(19) United States
(12) Patent Application Publication
(10) Pub. No.: US 2018/0122185 A1
(43) Pub. Date: May 3, 2018

(54) Player Tracking Card Reader With Interface For Cell Phone In Place Of Player Tracking Card

(71) Applicant: Kenneth L. Miller, (US)

(72) Inventor: Kenneth L. Miller, San Pedro, CA (US)

(21) Appl. No.: 15/799,038

(22) Filed: Oct. 31, 2017

Related U.S. Application Data
(60) Provisional application No. 62/415,284, filed on Oct. 31, 2016.

(51) Int. Cl. G07F 17/32; G06Q 20/32; H04W 4/00; H04B 5/00; G06K 19/06; G06K 7/08; G06K 7/00

(52) U.S. Cl. CPC G07F 17/3225; G07F 17/3244; G06Q 20/3274; H04W 4/008; G06K 7/1417; G06K 19/06037; G06K 7/087; G06K 7/0013; H04B 5/0031

(57) ABSTRACT

A player tracking reader that accepts traditional magnetic strip cards and contactless chip cards, that can also accept smart cell phones in lieu of a player tracking card is disclosed. The reader can positively verify that a player with a cell phone is physically present at a particular slot machine and has further means to verify the continued presence of the player. The reader communicates with existing slot machines by mimicking the communication protocol of a legacy card read while actually interfacing to a smart cell phone possessing a player ID number.

### CLAIM OF PRIORITY

This application claims priority from U.S. Provisional Application No. 62/415,284, filed on Oct. 31, 2016. The contents of that application in entirety are incorporated by reference.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

The present invention relates generally to a tracking card reader, and more particularly, to a tracking card reader that can accept a cell phone in place of a player tracking card.

### BACKGROUND

The gaming industry has relied on slot machines that have traditionally accepted coins for playing a wagering game. One innovation has been the use of player tracking cards that allow a player to swipe a card to activate a slot machine instead of inserting coins. In addition to convenience, a casino may track player data for promotional and marketing purposes based on a player's gaming patterns with cards. A player tracking reader is required to signal when a particular player is physically present at a particular slot machine by sending the player's assigned identification number to the host system. This occurs when a card is inserted into the reader. Likewise the reader must be able to signal when the player is no longer at the slot machine when the card is removed from the reader.

Another method to determine player presence is tracking through a cellular telephone. However, when it comes to cell phones it is more of a challenge to achieve a positive detection of a player being present at a particular slot machine. A radio frequency link alone cannot provide a positive indication of the exact machine where the player is located, considering the close proximity of other machines. The radio frequency link may very well connect to an adjacent machine and not to the one where the player is playing.

The majority of player tracking card readers in slot machines use a magnetic stripe card that is encoded with a player identification number. The main advantage of the magnetic stripe card is price, while the disadvantage is that it requires some level of manual skill by the player to get proper reads. To get a good read the card must be oriented with the magnetic stripe aligned with the read head on the card reader and it must be inserted in one smooth motion.

In more recent player tracking readers the ability to read contactless chip cards has been added. The advantage of such a feature is that player need only insert the card into the reader without regard to orientation or smoothness of motion. The ease of use comes at an increase in the card cost.

Now that a large percentage of the population has a smart cell phone it opens the possibility of using smart cell phones in place of a player card. Such a use would increase ease of use and eliminate the increase in card cost from use of contactless chip cards.

Thus, there is a need for a system that allows a cell phone to interact with a player tracking reader in such a way that it will appear to the host system that it is a play tracking card. Another need is for a player tracking reader that positively verifies that the player using a smart cell phone is in close proximity to the front of the slot machine. There is another need for a system to detect when a player using a smart cell phone is no longer near the slot machine and to terminate the transaction if not otherwise terminated. Another need is for a system to mimic the exact same communication sequences and protocol sent to host for card reads when the player is presenting a smart cell phone in lieu of a card. Yet another need is for a system that also accepts legacy cards, both magnetic stripe and contactless chip cards. There is also a need of a device that will facilitate upgrading existing player tracking systems that contains all the functional elements in a physical embodiment that will install into existing gaming equipment without any mechanical, electrical or operational modifications. Further, there is a need for a replacement device that reads existing cards that are manually inserted by the player similar to existing readers.

### SUMMARY

According to one example, a mobile device interface device is disclosed. The interface device includes a reader for reading readable data elements and a radio frequency transceiver. The interface includes a processor operable for verifying that a mobile device is in close proximity to the mobile device interface device via the radio frequency transceiver. The processor is operative to retrieve data from the mobile device via the reader reading readable data elements on the mobile device. The processor is operative to monitor the continued presence of the mobile device near the interface device. The device includes an interface capable of communication with other equipment.

Another example is a player tracking reader for use in a wagering game terminal. The reader includes a readable data element. The readable data element is operable to be read by a mobile device. The reader includes a radio frequency transceiver and a processor operable to verify that the mobile device is in close proximity to the wagering game terminal by receiving a signal from the mobile device after the mobile device reads the readable data element. The processor is operable to retrieve a player ID number from the mobile device via the radio frequency transceiver. The processor is operable to monitor the continued presence of the mobile device near the wagering game terminal via the radio frequency transceiver. The reader includes an interface capable of communication with other equipment.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a view of a typical slot machine showing the location of a player tracking reader, a barcode scanning camera, and the relationship of the cell phone displaying a barcode symbol to the reader.

FIG. 2 is a view of a typical slot machine showing the location of the player tracking reader, the location of the surface mounted barcode symbol, and the relationship of the cell phone scanning the barcode symbol to the reader.

FIG. 3 is a block diagram of a combination magnetic strip and contactless chip card reader with barcode scanning and radio (Bluetooth) communication.

FIG. 4 is a block diagram of an example mobile device such as the cell phone in FIGS. 1 and 2.

FIG. 5 is a flow diagram of the process by which the player tracking reader uses a mobile device as a player tracking card.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

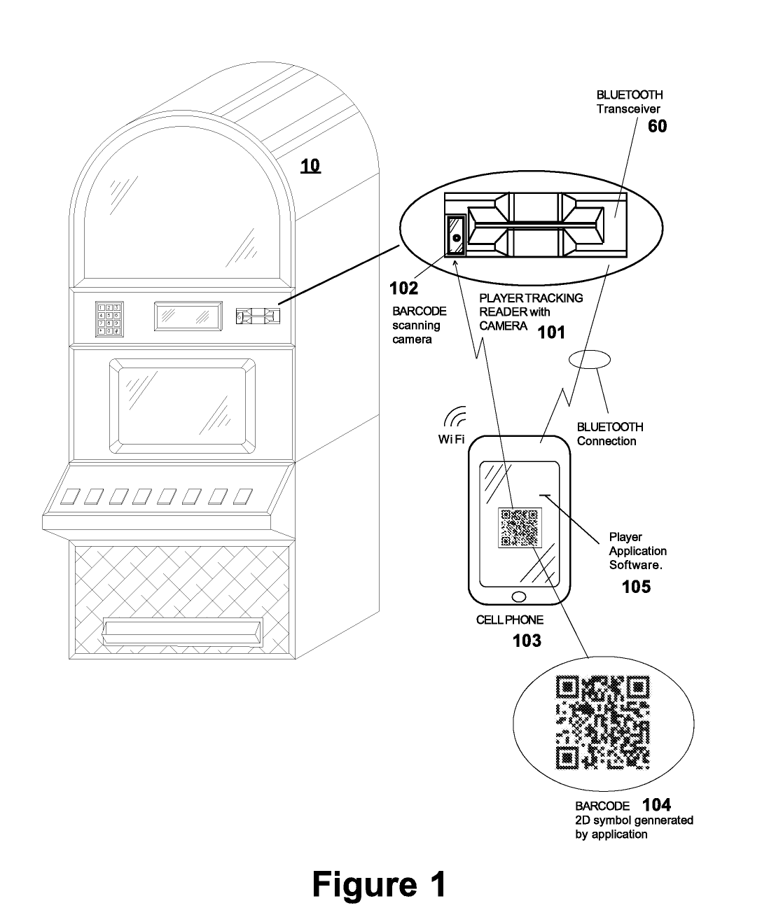

FIG. 1 shows typical wagering equipment that may be a wagering game terminal such as a slot machine 10 with the typical complement of player tracking and player interface devices including a player tracking system and wagering game controller. The player tracking system typically includes a manually operated player tracking card reader 101 to read a magnetic stripe or contactless chip player ID card. In addition to reading both magnetic stripe or contactless chip player cards, the reader 101 includes a barcode scanning camera 102 and a radio (Bluetooth) transceiver 60. Reader 101 is mounted in the same manner as an existing manually operated reader. Thus, the reader 101 may replace an existing manually operated reader without the need to perform any mechanical modifications to the mating gaming equipment and connects to the existing electrical cabling also without modification. It is to be understood that any wagering device with a player tracking system may employ the reader described herein. Further, the reader 101 may be installed as original equipment in the manufacture of a new wagering game machine.

The barcode scanning camera 102 scans the image of a readable data element such as a barcode symbol 104 displayed on the screen of a cell phone 103. The scanning range of the barcode scanning camera 102 is 6 to 12 inches in this example. The transmit power of the radio (Bluetooth) transceiver 60 is set below 1 milliwatt to limit its range in this example. It is to be understood that any mobile device that has a radio transceiver and is capable of displaying a barcode symbol may be used for the cell phone 103.

The radio (Bluetooth) transceiver 60 allows communication with the cell phone 103 via a built-in Bluetooth transceiver on the cell phone 103. Application software 105 generates the barcode symbol 104, which contains the players ID number or other information used in establishing the Bluetooth connection with the phone 103. The application software 105 also manages the data connection to the player tracking reader 101.

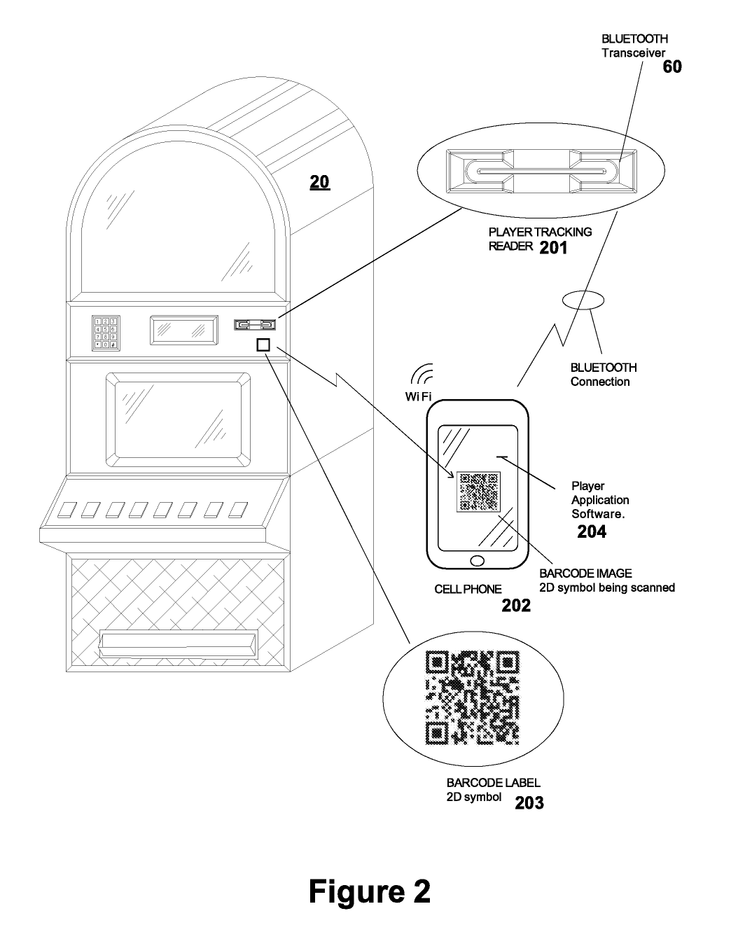

FIG. 2 shows an alternate configuration of a typical slot machine 20 with the typical complement of player tracking and player interface devices. The player tracking system typically includes a player tracking card reader 201 to read the player's magnetic stripe or contactless chip player ID card. In addition, the reader 201 includes only a radio (Bluetooth) transceiver 60.

A barcode symbol 203 is affixed to the front panel of the slot machine 20 and is scanned by the application software 204 using the built-in camera of the cell phone 202. The barcode symbol 203 contains the slot machine number or other information used in establishing the Bluetooth connection.

The scanning range of the built-in camera of the cell phone 202 is in the range of 6 to 12 inches in this example. The transmit power of the radio (Bluetooth) transceiver 60 is set below 1 milliwatt to limit its range. The radio (Bluetooth) transceiver 60 allows communication with cell phone 103 via the phone's built-in Bluetooth transceiver. The application software 204 also manages the data connection to the player tracking reader 201.

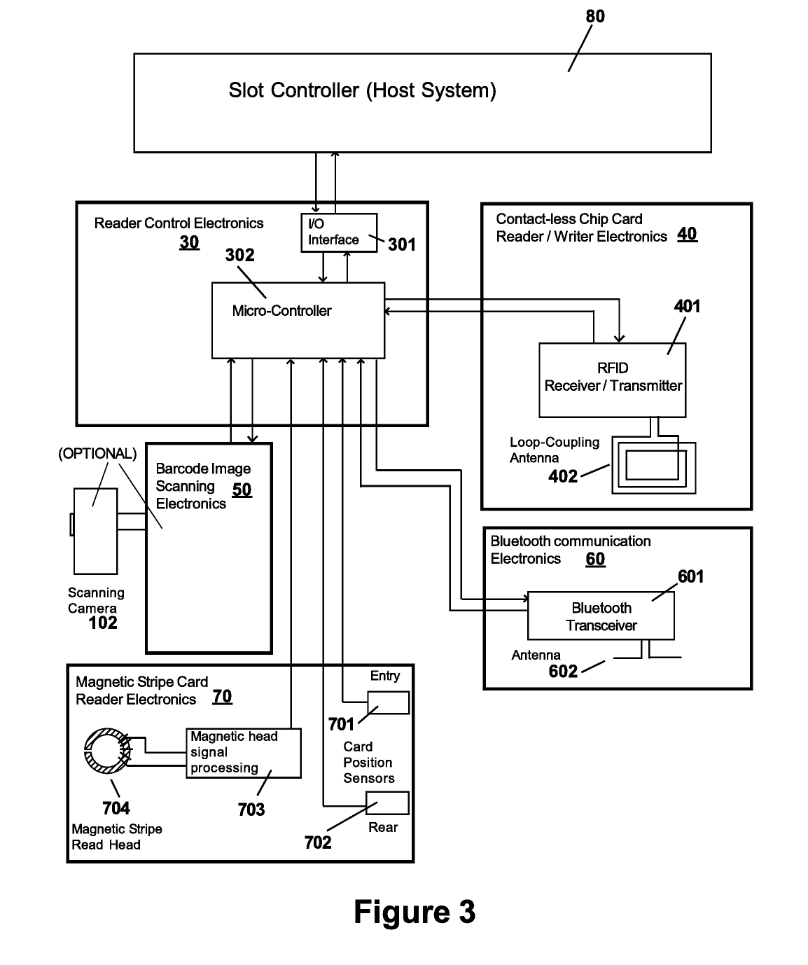

FIG. 3 is a block diagram of a combination magnetic strip and contactless chip card reader with barcode scanning and radio (Bluetooth) communication such as the combination reader 101 in FIG. 1 or the tracking card reader 201 in FIG. 2. FIG. 3 shows the functional organization of the tracking system and the relationship between the functional elements. A slot controller 80 controls the operation of the slot machine and interfaces with an existing player tracking reader. The slot controller 80 communicates with reader control electronics 30. An I/O interface 301 sends to and receives data from the slot controller 80. The I/O interface 301 may be a variety of types, including TTL (+5V/0V) level interface, RS-232 (+V/−V) or USB.

The reader control electronics 30 has a processor such as a micro-controller 302, which processes the magnetic stripe and contact-less chip card commands, receives barcode information from the barcode image scanning electronics 50, and sends and receives data from the Bluetooth communication electronics 60. The reader control electronics 30 monitors the card position and decodes the data stream recovered from a magnetic stripe on a card via a magnetic stripe card reader electronics 70.

The magnetic stripe card reader electronics 70 includes a magnetic stripe read head 704 connected to a magnetic head signal processing circuit 703. The magnetic head signal processing circuit 703 converts the raw head signal to logic levels for the micro-controller 302.

An entry card position sensor 701 and a rear card position sensor 702 detect the card position of an inserted card. The entry sensor 701 signals the micro-controller 302 when a card is detected at the entry of the reader and likewise the rear sensor 702 signals when a card is at the rear of the reader (fully inserted).

The reader control electronics 30 connects to an RFID receiver/transmitter 401 located in a contact-less chip card reader/writer electronics 40. The RF receiver/transmitter 401 is connected to a loop-coupling antenna 402, which in turn couples to a contactless card to be read.

A Bluetooth communication electronics 60 includes a Bluetooth receiver/transmitter 601 which is connected to an antenna 602. The Bluetooth receiver/transmitter 601 performs all the low level communications with a cell phone such as the cell phone 103 in FIG. 1.

In the case of the alternate configuration shown in FIG. 2, the barcode image scanning electronics 50 including the scanning camera 102 in FIG. 3 is not required.

The operation of the reader system may be explained in reference to FIG. 3. When a legacy card, either magnetic stripe card or contact-less chip card is inserted into the player tracking reader 101 in FIG. 1, the entry card position sensor 701 will signal that a card has entered. The micro-controller 302 will first attempt to read a magnetic stripe card. When the rear position sensor 702 signals the card is fully inserted, the reader 101 will then proceed with processing the magnetic stripe data if encoded data is present. The micro-controller 302 can then activate the contact-less chip card reader/writer electronics 40 to check if the card contains a contactless chip.

When a magnetic stripe card is inserted manually in a continuous motion into the player tracking reader 101 with the magnetic stripe aligned with the magnetic head 704, the encoded data on the magnetic stripe is read by the magnetic stripe reader electronics 20, which includes the magnetic head signal processing circuit 703 in FIG. 3.

The micro-controller 302 is alerted by the entry card position sensor 701 that a card has entered the reader and to prepare to start decoding the data stream from the magnetic head signal processing circuit 703. The decoding process consists of determining “1” logic bits from “0” logic bits, while correcting for the card speed. The bits are grouped into eight bits and stored in memory. When the card is fully inserted, and is sensed by the rear card position sensor 702, the micro-controller 302 knows to end the decoding process.

If magnetic stripe encoded data was not detected, the micro-controller 302 activates the RFID receiver/transmitter 401 in order to test if a contact-less chip card is inserted in the reader 101. If detected, the contact-less chip card reader/writer electronics 40 will be left active and the slot controller 80 signals that a chip card is present and can proceed with communications. If neither magnetic stripe encoded data nor the presence of a contact-less chip card was detected, an error will be signaled indicating that a magnetic card may have been inserted incorrectly.

Unlike a magnetic stripe card, data on a contact-less chip card is read when the card is fully inserted and is not in motion. All communication is performed via a radio frequency link, which provides both bi-directional communication and a source of power. When the RFID receive/transmitter 401 is activated a RF (radio frequency) carrier is applied to the loop coupling antenna 402. The power of the RF carrier is of sufficient magnitude that the current induced into the loop antenna in the contact-less chip card will be great enough to power the embedded chip in the card. The communication to the embedded chip containing the player ID number can then be established.

When a player wants to log on to a particular wagering game machine such as the slot machine 10 using a cell phone as a player tracking card the procedure is as follows in reference to FIG. 1. The player will activate a player application 105 resident on the cell phone 103. The player application 105 will generate a barcode symbol 104 on the cell phone screen. The barcode symbol 104 contains the player ID number associated with the player. Other information may be coded on the barcode symbol 104.

The player confirms his physical presence by presenting the barcode symbol 104 to the barcode scanning camera 102 by facing the cell phone screen toward the camera 102. The range of the barcode scanning camera 102 is in the range of 6 to 12 inches in this example. The player tracking reader 101 obtains the player ID from the image and connects to the cell phone 103 via the Bluetooth signal.

The player tracking reader 101 having obtained the Player ID number from the barcode symbol 104. The player tracking reader 101 indicates to the player application 105 via the Bluetooth signal that it has received the player ID number and is ready. The player application 105 will then initiate the Bluetooth connection with the reader 101. Once connected, the player tracking reader 101 will send the player ID number back to the player application 105 to verify that the connection is to the correct slot machine.

It is important to note that the fact that the barcode must be scanned within a certain number of inches of the machine so there is no question as to which machine the player is selecting to log onto.

Once the connection is made and verified by the player tracking reader 101 the reader 101 will then send the player ID number to the slot controller (Host) 80. Since the slot controller (Host) 80 expects only cards the micro controller 302 will, for barcode reads, mimic a card insertion before sending the player number. This is accomplished by first sending a card detected at the entry signal, normally sent when the entry card sensor 701 senses a card, followed by a card fully inserted signal, normally sent when the rear card sensor 702 senses a card. The player ID number is then sent just as a card sourced player ID number would have been.

The player is now logged onto the slot machine just as if he had inserted a card. As long as the player tracking reader 101 can maintain contact with the cell phone 103 the player will remain logged on. The player thus gains access to operate the slot machine and thereby play a wagering game. The player also is given access to a player tracking system that may be part of a networked system that is connected to the slot machine.

When the player decides to log off of the slot machine 10, the player can log off by instructing the player application 105 to signal the player tracking reader 101 that the player is logging off of the slot machine 10, followed by shutting down the Bluetooth connection. If the player forgets to log off through the application 104, an automatic log off occurs when the player leaves and moves out of range of the Bluetooth transceiver 60. The Bluetooth transceiver 60 power is set at a reduced range, which may be less than 10 feet in this example.

In response to a log off the micro-controller 302 in the player tracking reader 101 will signal the slot controller (Host) 80 the log off by mimicking a card removal, by first signaling card not detected at the rear card sensor 702 followed by a card not detected at the entry card sensor 701.

FIG. 2 shows an alternate method of using a cell phone 202 as a player tracking card. The log on also involves scanning a barcode symbol 203 in the log on process. In this alternate method, the cell phone 202 is used to scan a barcode symbol 203 affixed to the front of the slot machine 20. The scanning of the barcode symbol 203 is used to confirm that the player is physically present at the machine being selected.

When a player desires to log onto a particular slot machine the procedure is as follows with reference to FIG. 2.

The player activates the player application 204 resident on the cell phone 202. The player application 204 will enter barcode scanning mode. The player then aims the phone camera at the barcode symbol 203 affixed to the front of the slot machine 20. When the image of the symbol is centered on the screen the application 204 will scan the symbol. The symbol contains the slot machine ID number and the ID number of the player tracking reader 201.

To allow readers to be changed in a slot machine without having to reprint a barcode label 203, the player application 203 may alternately connect to a remote data base via a Wi-Fi network to retrieve the address information for that slot machine.

The cell phone 202 now having the ID number of player tracking reader 201 will connect to the tracking reader 201. At this point the cell phone 202 will send the player ID number to the tracking reader 201.

As before, the micro-controller 302 will send the player ID number to the slot controller (Host) 80 by mimicking a card insertion before sending the player number.

The player is now logged on to the slot machine 20 just as if they had inserted a card in the player tracking reader 201. As long as the player tracking reader 201 can maintain contact with the cell phone 202 the player will remain logged on.

The player can log off by instructing the player application 204 to signal the player tracking reader 201 that the player is logging off or by moving greater than a predetermined distance such as 10 feet away, causing the Bluetooth connection to break resulting in an automatic log off.

In response to a log off the micro-controller 302 in the player tracking reader 201 will signal the slot controller (Host) 80 by mimicking a card removal, by first signaling card not detected at the rear card sensor followed by a card not detected at the entry card sensor.

Certain cell phones have Near Field Communication (NFC) capabilities, which opens the possibility of substituting NFC tags in place of the barcode symbol. Alternatively, communication may be accomplished with NFC hardware imbedded in a player tracking reader directly in order to pass the player ID number and Bluetooth address information. With the range of NFC being around 4 inches it more than satisfies the requirement of positive verification that the player is in close proximity to a particular slot machine.

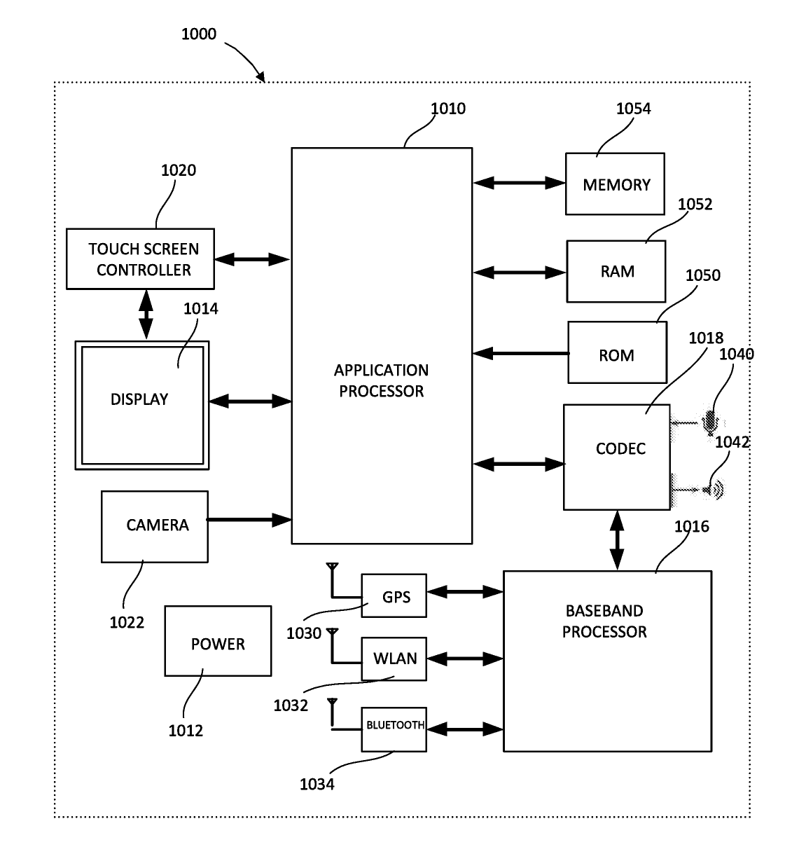

FIG. 4 is a block diagram of the components of a mobile user device 1000 such as the cell phone 103 in FIG. 1 or the cell phone 202 in FIG. 2. The mobile user device 1000 includes an application processor 1010, a power source 1012, a display 1014, a baseband processor 1016, and a CODEC 1018. In this example, the display 1014 is an LCD touch screen that allows the user to control the applications run by the application processor 1010 via touch inputs as well as view graphics generated by the application processor 1010. The display 1014 is controlled by a touch screen controller 1020. The application processor 1010 may be coupled to various devices such as a camera 1022 and other interfaces such as a communication port, etc.

The baseband processor 1016 receives signals from a network transmitter receiver 1030 allowing communications with a network, a geo-referencing receiver 1032 that allows the reception of positioning data to determine the location of the mobile device 1000, and a Bluetooth transceiver 1034 that allows communications via Bluetooth. The baseband processor 1016 processes in the signals and is coupled to the CODEC 1018, which converts the signals for use by the application processor 1010. The CODEC 1018 also decodes audio signals received by a microphone 1040 and encodes data signals for output by a speaker 1042 for functions such as a telephone application run by the applications processor 1010. Of course other audio devices such as a headset may be coupled through the CODEC 1018.

The processors 1010 and 1016 may be conveniently implemented using one or more general purpose computer systems, microprocessors, digital signal processors, micro-controllers, application specific integrated circuits (ASIC), programmable logic devices (PLD), field programmable logic devices (FPLD), field programmable gate arrays (FPGA), and the like, programmed according to the teachings as described and illustrated herein, as will be appreciated by those skilled in the computer, software, and networking arts.

The operating system software and other applications are stored on read only memory (ROM) 1050, random access memory (RAM) 1052 and a memory storage device 1054 for access by the applications processor 1010. In this example, the memory storage device 1054 is flash memory, but other memory devices may be used. The applications stored on the memory storage device 1054 include the emotional score data collection and broadcast application, which creates interface graphics on the display and interfaces with a browsing application. Of course other forms of applications may incorporate the principles explained above. In this example, the player application may be preloaded on the mobile user device 1000, or may be offered as an application that may be downloaded to the mobile user device 1000 from a network device.

The memory storage device 1054 includes a machine-readable medium on which is stored one or more sets of instructions (e.g., software) embodying any one or more of the methodologies or functions described herein. The instructions may also reside, completely or at least partially, within memory storage device 1054, the ROM 1050, the RAM 1052, and/or within the processors 1010 or 1016 during execution thereof by the mobile device 1000. While the machine-readable medium is shown in an example to be a single medium, the term “machine-readable medium” should be taken to include a single medium or multiple media (e.g., a centralized or distributed database, and/or associated caches and servers) that store the one or more sets of instructions. The term “machine-readable medium” can also be taken to include any medium that is capable of storing, encoding, or carrying a set of instructions for execution by the machine and that cause the machine to perform any one or more of the methodologies of the various embodiments, or that is capable of storing, encoding, or carrying data structures utilized by or associated with such a set of instructions. The term “machine-readable medium” can accordingly be taken to include, but not be limited to, solid-state memories, optical media, and magnetic media.

A variety of different types of memory storage devices, such as a random access memory (RAM) or a read only memory (ROM) in the system or a floppy disk, hard disk, CD ROM, DVD ROM, flash, or other computer readable medium that is read from and/or written to by a magnetic, optical, or other reading and/or writing system that is coupled to the processor, may be used for the memory or memories in the user device 1000.

The above described player tracker system allows casino operators to take advantage of the proliferation of smart cell phones by allowing them to turn the phone into a play identification device (a player tracking card). The player tracker reader devices 101 and 201 shown in FIGS. 1 and 2 are preferably manufactured in the same physical dimensions as existing player tracking card readers installed in wagering game machines. For example, existing card readers include Advanced Casino Systems/Bally readers manufactured by XS Technonlogy, Inc. and Acres Gaming/International Gaming Technology readers manufactured by Panasonic. The devices 101 and 201 shown in FIGS. 1 and 2 facilitates upgrading existing player tracking systems by replacing such legacy systems with the device 101 or the device 201, that each contain all the functional elements in a physical embodiment that will install into existing gaming equipment without any mechanical, electrical or operational modifications. As explained above such replacement devices as explained above in relation to FIGS. 1 and 2 read existing cards that are manually inserted by the player similar to existing readers. Thus, gaming machines such as slot machines may be retrofitted with the devices 101 and 201 in FIGS. 1 and 2 to add the ability of accepting a cell phone as a player tracking card.

The positive detection of the player presence can be achieved by including a means of determining that the cell phone is in close proximity to the slot machine and a means to determine that the phone is no longer near the slot machine. To satisfy the positive player presence requirement the invention includes a barcode symbol reading function, which must be read at close range, and a low power radio frequency communications link between the phone and the player tracking reader, which monitors the continuing presence of the phone within a limited distance.

Thus, the combination of the barcode symbol reading function and the low power radio frequency communications link can be used to make a cell phone behave like a traditional player's card.

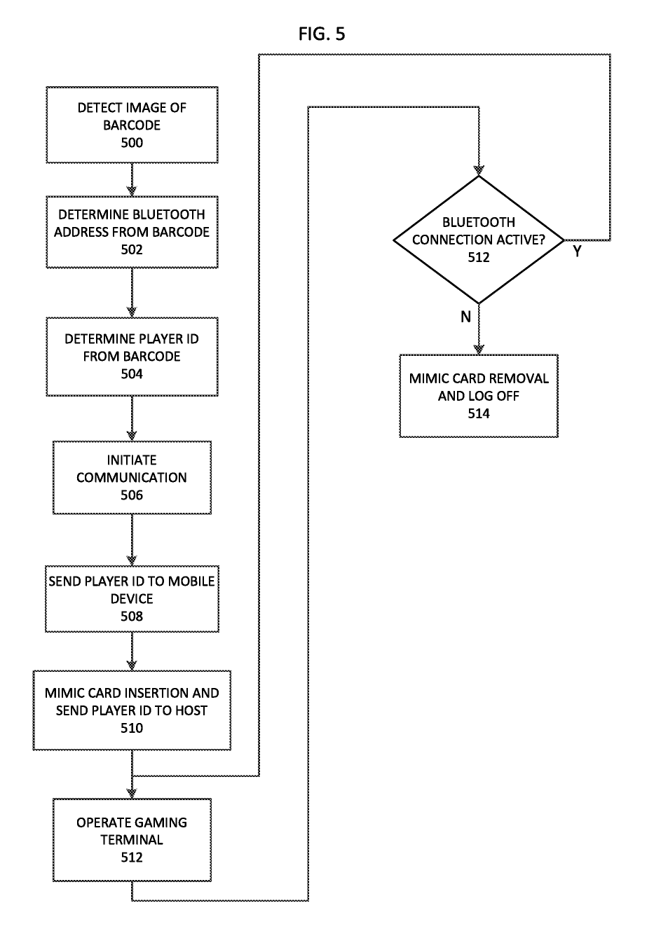

FIG. 5 shows a flow diagram of the code executed by the player tracker 101 in FIG. 1 to obtain player ID and proximity information using a mobile device such as the cell phone 103 in FIGS. 1-4. The flow diagram in FIG. 5 is representative of example machine readable instructions for the micro-controller 302 in FIG. 3. In this example, the machine readable instructions comprise an algorithm for execution by: (a) a processor, (b) a controller, and/or (c) one or more other suitable processing device(s). The algorithm may be embodied in software stored on tangible media such as, for example, a flash memory, a CD-ROM, a floppy disk, a hard drive, a digital video (versatile) disk (DVD), or other memory devices, but persons of ordinary skill in the art will readily appreciate that the entire algorithm and/or parts thereof could alternatively be executed by a device other than a processor and/or embodied in firmware or dedicated hardware in a well-known manner (e.g., it may be implemented by an application specific integrated circuit (ASIC), a programmable logic device (PLD), a field programmable logic device (FPLD), a field programmable gate array (FPGA), discrete logic, etc.). For example, any or all of the components of the interfaces could be implemented by software, hardware, and/or firmware. Also, some or all of the machine readable instructions represented by the flowchart of FIG. 5 may be implemented manually. Further, although the example algorithm is described with reference to the flowcharts illustrated in FIG. 5, persons of ordinary skill in the art will readily appreciate that many other methods of implementing the example machine readable instructions may alternatively be used. For example, the order of execution of the blocks may be changed, and/or some of the blocks described may be changed, eliminated, or combined.

The micro-controller 302 first detects whether the camera 102 can read a barcode on the cell phone 103 in proximity to the camera 102 (500). The barcode 104 is decoded by the micro controller 302 and the Bluetooth address ID number of the cell phone 103 is determined (502). The player ID is also obtained from the barcode 104 (504). The micro controller 302 in conjunction with the cell phone 103 will indicate via the Bluetooth signal that communication may be initiated (506). The micro controller 302 will use the transceiver 60 to send the player ID back to the cell phone 103 to verify the connection is to the correct slot machine (508).

Once the connection is verified, the micro controller 302 mimics a card insertion by sending signals to the card sensors 701 and 702 and then sending the player ID to the slot controller 80 (510). Once the player ID is sent, the slot machine 10 may be operated by the player (512) and other systems such as the player tracking system may receive data from the slot machine 10 associated with the player. The micro controller 302 determines whether the Bluetooth connection is active, indicating the player is still in proximity to the slot machine (512). If the connection is active, the micro controller 302 allows the operation of the slot machine 10 to continue (510). If the connection is not active, the micro controller 302 will mimic card removal by signaling the card sensors 701 and 702 that a card is not detected and thereby log off the host (514).

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A mobile device interface device comprising:
a reader for reading readable data elements;
a radio frequency transceiver;
a processor operable for verifying that a mobile device is in close proximity to the mobile device interface device via the radio frequency transceiver; retrieving data from the mobile device via the reader reading readable data elements on the mobile device; and monitoring the continued presence of the mobile device near the interface device; and
an interface capable of communication with other equipment.

2. The device of claim 1, wherein the data retrieved and the continued presence of the mobile device is used to gain access to operate the other equipment.

3. The device of claim 1, wherein the other equipment is a wagering game terminal.

4. The device of claim 1, wherein the reader is limited to reading readable data elements of the mobile device within less than a predetermined distance.

5. The device of claim 1, wherein the mobile device is a cell phone.

6. The device of claim 1, wherein the radio frequency transceiver is operable to communicate using Bluetooth protocol.

7. The device of claim 1, wherein the readable data element is a bar code symbol displayed on a display of the mobile device.

8. The device of claim 1, wherein the readable data element is a Near Field Communication tag on the mobile device.

9. The device of claim 1, wherein the retrieved player ID number and the continued presence of the mobile device allows access to a player tracking system

10. A player tracking reader for use in a wagering game terminal comprising:
a readable data element, the readable data element operable to be read by a mobile device;
a radio frequency transceiver;
a processor operable to verify that the mobile device is in close proximity to the wagering game terminal by receiving a signal from the mobile device after the mobile device reads the readable data element, retrieve a player ID number from the mobile device via the radio frequency transceiver; and monitor the continued presence of the mobile device near the wagering game terminal via the radio frequency transceiver; and
an interface capable of communication with other equipment.

11. The device of claim 10, wherein the retrieved player ID number and the continued presence of the mobile device allows access to a player tracking system.

12. The device of claim 10, wherein the readable element is one of a barcode symbol is replaced or a Near Field Communication (NFC) tag.

13. The device of claim 10, wherein the other equipment is a wagering game controller.

14. The device of claim 10, wherein the mobile device is a cell phone.

15. The device of claim 10, wherein the radio frequency transceiver is operable to communicate using Bluetooth protocol.
